(19) United States
(12) Patent Application Publication
(10) Pub. No.: US 2009/0240590 A1
(43) Pub. Date: Sep. 24, 2009

(54) Interactive And Adaptive Messaging Systems

(76) Inventors: Tal Or, Tel Aviv (IL); Joshua Rothfarb, Kfar Saba (IL)

Correspondence Address: William H. Dippert;Eckert Seamans Cherin & Mellott, LLC, U.S. Steel Tower, 600 Grant Street, 44th Floor, Pittsburgh, PA, 15219, US

(21) Appl. No.: 11/721,211

(22) PCT Filed: Dec. 8, 2005
(86) PCT No.: PCT/IL2005/001328

§ 371 Date: Jun. 8, 2007

Related U.S. Application Data
(60) Provisional application No. 60/634,691, filed on Dec. 9, 2004.

(51) Int. Cl. G06Q 30/00; G01C 21/00; H04N 5/335; G08B 21/00; H02J 7/00

(52) U.S. Cl. 705/14.58; 701/300; 705/14.63; 705/14.64; 348/308; 340/686.1; 320/137; 348/E05.091

(57) ABSTRACT

The present invention provides a new interactive and adaptive messaging system and method adapted to allow effective communication and relationship between customers, owners of a confined predetermined area and advertisers. The system comprises at least one server adapted to receive content from the customers, the owners, the advertisers, and the predetermined area and to create relevant information and adapted to distribute the information to the customers. A part of the information is distributed when the customer is identified by the messaging system to enter the predetermined area and another part of the information is distributed to the customer according to content received by the server from the customer or the predetermined area. The customers are exposed to the information regularly as they are traveling within the predetermined area as well as at specific locations and times within the predetermined area.

### FIELD OF THE INVENTION

The present invention relates to communication systems. More particularly, the present invention relates to an interactive and adaptive messaging system based on relationship management.

### BACKGROUND OF THE INVENTION

Customers and advertisers become more and more sophisticated. Customers would like to shop and receive services and information in a controlled and effective manner that would help them make their decisions. Advertisers, on the other hand, would like to transfer their ideas and information to the customers in the right place, at the right time and without annoying the customers that hear or see the advertisement messages in situations where they don't relate to the advertising materials. Moreover, in many situations, the advertising material is not relevant to the customer, a fact that creates a disadvantage to the customer as well as the advertising party in which cases it would be better not to transfer it.

Methods and devices had been developed all through the Internet era in order to establish a better communication between the customer and the advertisers using interactive management systems so as to better meet the needs of the customers. Examples are customer interactive shopping and marketing systems described by Symbol Technologies Inc., in which a portable data terminal for communicating information over a communication system is provided. The described systems have aspects that may be used within a shopping establishment or at a user's home. An example of such system is taught in U.S. patent application Ser. No. 10/957,819 (published as US2005/0040230) “Customer Interactive shopping system” by Swartz et al.

Other terminals adapted to be provided to the user in the shop had been developed in order to allow the customer to interact with his home PC and his own shopping list as well as with information provided to him through the net, such as advertisements. However, the available systems are very limited in the information that is provided to the customers as well as the advertisers. There is a need to provide a system that is highly interactive, adaptive and self taught so that the customer is provided only with relevant information available at the right time and the right place and when the customer is in full awareness and interested in the information provided. There is a need for a high performance communication system in which messages will be transferred through the system and will be processed during the transfer at the right place so as to minimize overhead.

### SUMMARY OF THE INVENTION

It is an object of the present invention to provide a focused interactive and adaptive messaging system through which information and eaServices, which are the add on electronic adaptive services, are transmitted between three parties—customers who are traveling within a confined service area, owners of the confined service area and advertisers who wishes to provide sectioned messages to sectioned customers in certain locations and in specific time zone. The messages and the information transmitted to the customer is dependent on time, location, customer parameters, customer behavior and media properties, and are adjustable accordingly.

It is another object of the present invention to provide an electronic platform on which extra services (eaService) can be delivered to the customer so as to help him obtain the service provided in the confined area, in an effective manner with regard to his specific needs and lifestyle and/or help the owners to provide the service in an appropriate manner.

It is an additional object of the present invention to provide an interactive and adaptive messaging system by which the customers are communicating with the system through a device that is a Personal Communication Unit (PCU) so that when the customer is in a confined shopping environment, the PCU can be mounted on a shopping cart, trolley, or any other goods collecting means; in any manner, the PCU should be in front of the customer. The location of the customer can be tracked by the system and be used for providing the material to be advertised according to the campaign definition in a controlled and adaptive manner.

It is thus provided in accordance with a preferred embodiment of the present invention an interactive and adaptive messaging system adapted to allow effective communication (relationship) between customers, owners of a confined predetermined area and advertisers, the system comprising:
at least one server adapted to receive content from the customers, the owners, the advertisers, and the predetermined area and to create information and adapted to distribute said information to the customers, wherein a part of the information is distributed when the customer is identified by the messaging system and another part of the information is distributed to the customer according to content received by said at least one server from the customer or the predetermined area.

whereby the customers are exposed to the information regularly as they are traveling within the predetermined area as well as at specific locations within the predetermined area.

Furthermore and in accordance with another preferred embodiment of the present invention, said content received by said at least one servers is controlled so as to prevent non relevant information from being loaded into said at least one server.

Furthermore and in accordance with another preferred embodiment of the present invention, said content received by said at least one servers is processed and analyzed.

Furthermore and in accordance with another preferred embodiment of the present invention, said information comprises advertising campaigns.

Furthermore and in accordance with another preferred embodiment of the present invention, the system further provided with a plurality of tags wherein each one of the tags is adapted to be identified with one of the customers and wherein said plurality of tags are adapted to be identified and monitored when traveling within the confined and predetermined area,

Furthermore and in accordance with another preferred embodiment of the present invention, a plurality of receivers are provided within the predetermined area and wherein said plurality of receivers are adapted to communicate with said plurality of tags, and wherein information received by said receivers is included in said content.

Furthermore and in accordance with another preferred embodiment of the present invention, the system further comprises a plurality of personal communication units (PCU) adapted to be available to the customers in the predetermined area and wherein said plurality of PCU is adapted to be mounted in shopping carts and wherein the information and said advertising campaigns are transmitted to said plurality of PCU.

Furthermore and in accordance with another preferred embodiment of the present invention, said PCU is selected from a group such as computer monitor, palm computers, or mobile computers.

Furthermore and in accordance with another preferred embodiment of the present invention, said advertising campaigns is transmitted by a manner that is selected from a group of visual (Picture, Movie, etc.), vocal, or textual.

Furthermore and in accordance with another preferred embodiment of the present invention, the information received in said at least one receiving server is selected from a group of information such as type of predetermined area, data bases, personal information send by the customers via TCP/IP or Cellular SMS or MMS, or via any other means, and RFID, and barcodes.

Furthermore and in accordance with another preferred embodiment of the present invention, the system further comprising a plurality of markers distributed on the predetermined area; and a sensor associated with the customers and adapted to allow localization of the customers within the predetermined area.

Furthermore and in accordance with another preferred embodiment of the present invention, said sensor is provided on a bottom of plurality of shopping carts wherein said sensor is adapted to identify said plurality of markers.

Furthermore and in accordance with another preferred embodiment of the present invention, said sensor is a CMOS camera.

Furthermore and in accordance with another preferred embodiment of the present invention, said shopping carts are provided with batteries.

Furthermore and in accordance with another preferred embodiment of the present invention, said batteries are rechargeable.

Furthermore and in accordance with another preferred embodiment of the present invention, said batteries are recharged in a manner such as induction or a generator.

Furthermore and in accordance with another preferred embodiment of the present invention, said generator is a dynamo generator that is activated by movements of the shopping cart.

Furthermore and in accordance with another preferred embodiment of the present invention, said predetermined area is divided into a plurality of sections and wherein a reminder list is adapted to be updated according to movements of the customers among said plurality of sections.

Furthermore and in accordance with another preferred embodiment of the present invention, the customer receives an indication that he has moved to one of said plurality of sections.

Furthermore and in accordance with another preferred embodiment of the present invention, the customer can activate an updating procedure of said reminder list in response to said indicator.

Furthermore and in accordance with another preferred embodiment of the present invention, the system further comprising a tracking system adapted to identify the positioning of the customer or the shopping cart in the predetermined area.

Furthermore and in accordance with another preferred embodiment of the present invention, said tracking system comprises at least one camera.

Furthermore and in accordance with another preferred embodiment of the present invention, said content can be received from identified items that are being purchased by the customers.

Furthermore and in accordance with another preferred embodiment of the present invention, said content can be received from identified items that are being dispensed by the customers.

Furthermore and in accordance with another preferred embodiment of the present invention, said identified items are provided with an identification means selected from a group of means such as barcode or RFID tag.

Furthermore and in accordance with another preferred embodiment of the present invention, predetermined area is selected from a group of areas such as retailer's chains, airport area, airplanes, train stations, the trains themselves, boats, mall, parks.

In addition and in accordance with yet another preferred embodiment of the present invention, it is provided a method of interactive and adaptive communication and relationship between customers, owners of a confined predetermined area and advertisers comprising:
collecting content to at least one receiving server that is adapted from the customers, the owners, the advertisers, and the predetermined area;
creating information;
distributing a part of said information through at least one distributing server to the customers when the customer is identified in the predetermined area;
tracking the customers within the predetermined area;
transferring location content to said at least one receiving server;
distributing another part of the information to the customers according to content received by said at least one receiving server and to said location content;

whereby the customers are exposed to the information regularly as they are traveling within the predetermined area as well as at specific locations within the predetermined area.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 schematically illustrates a relationship management platform in accordance with a preferred embodiment of the present invention.

FIG. 2 schematically illustrates an interactive and adaptive messaging system in accordance with a preferred embodiment of the present invention.

FIG. 3 illustrates tracking system in accordance with a preferred embodiment of the present invention.

FIG. 4 illustrates camera-based tracking system in accordance with another preferred embodiment of the present invention.

FIG. 5 illustrates a shopping cart in accordance with a preferred embodiment of the present invention.

FIG. 6 illustrates more details of the shopping cart's charger in accordance with a preferred embodiment of the present invention.

FIG. 7 illustrates a system for recharging the batteries in the shopping carts in accordance with a preferred embodiment of the present invention.

### DETAILED DESCRIPTION OF THE INVENTION AND FIGURES

The present invention provides a system that is basically a unique and novel-platform allowing effective communication between the forces that act in a predetermined and confined area: the owners of the area that wish for more customer and aspire for customer loyalty, the customers that travel within the confined area, being exposed to products and services, and consume them in the confined area as well as in another location; and the advertisers who wish to advertise their products or services in the most effective manner.

According to one aspect of the present invention, the system is operated by media service provider (MSP) who usually specializes in providing media services in confined service areas, and serves the advertisers who wish to create campaigns for the customers at the confined areas. The owners of a predefined and confined area (or a chain of such areas) may also act as MSP. Any MSP is responsible for all the areas he operates and preferably, the operation is controlled from a center called processing center site (PCS).

According to another aspect of the present invention, advertisers are defined as advertisers of products or services offered in the confined area or other content providers that provides information and campaigns regarding the offered products or services. An owner can also provide content and can be covered in the definition of advertiser. The content provided by the MSP can be related to campaigns (ads, coupons, messages, commercials, news and more) or eaServices (information on products, news, and any other information). Some of this content is being collected by the system and is provided at all times. Campaigns are being produced by the advertisers and distributed by the system from the PCS to the confined areas. As the customer enters the confined area, the system fetches the eaServices he should be exposed to and adaptively applies them. In addition the system fetches the campaigns that fit the customer profile, location and timing using an automatically queuing subsystem determines which one (if any) will be transferred to the customer's PCU. All through the time the customer is within the confined area, the system logs the customer's location, activities and decisions and sends it to be processed and analyzed by the PCS.

According to yet another aspect of the present invention, the information received by the PCS is being controlled and statistically analyzed so as to establish a more adaptive and self-taught system that can screen, filter and direct the information sent to the customer. The content can be information regarding a plurality of customers, information gathered by the confined area's owners, advertisers, information on products and services, and other providers.

In another aspect, the information received within the MSP is being controlled and statistically analyzed so as to establish a more adaptive and self-taught system that can screen, filter and direct the information sent to the customer by the MSP.

According to yet another aspect of the present invention, data is collected to an interactive and adaptive system using readers like RFID readers or Barcode scanners or alike devices that are provided in any place in which the customers purchase or dispense items.

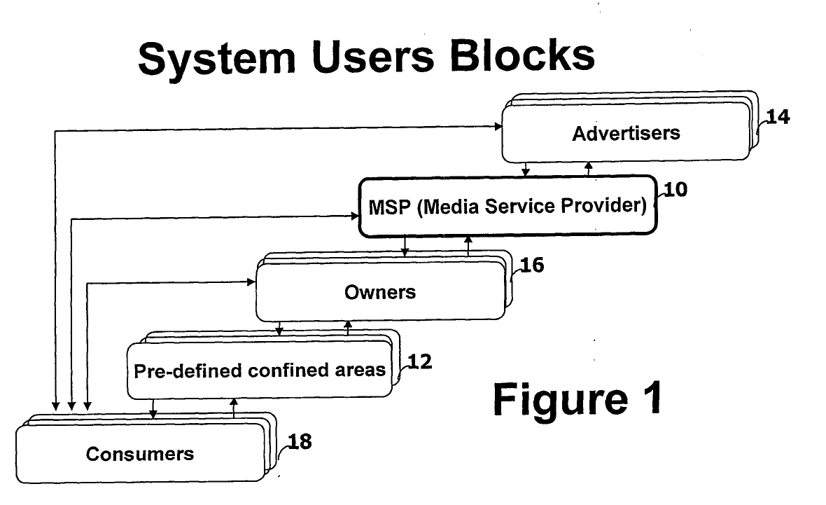

Reference is now made to FIG. 1 schematically illustrating a relationship management platform in accordance with a preferred embodiment of the present invention. The platform onto which an MSP 10 controls and interacts with are three forces that are acting within at least one of a plurality of confined areas 12. The relationship management platform allows communication between advertisers 14, owners 16 of confined areas 12, and customers 18 that are traveling within the area. The communication between the forces in the relationship management platform is performed through MSP 14 that is preferably adapted to analyze the information gathered from all parties. Customers 18 are interacting with all components of the system. Customers are defined as individuals, companies, families or any other entity that has a common consumption. A predetermined area is selected from a group of areas such as retailer's chains, airport area, airplanes, train stations, the trains themselves, boats, mall, parks, and any other confines area wherein services or products are being consumed.

As an example, customers 18 are traveling in confined area 12 such as a supermarket while guiding a shopping cart system as will be shown herein after. Owners 16 can own several confined areas. Advertisers 14 are providing the products or services that are being supplied within confined areas 12 and are interested in advertising their products in a focused manner, i.e., when the customer is in the store, looking for the specific products.

As mentioned herein before, advertising in supermarkets or other stores is known in the art, however, the advertisements are arbitrarily provided all over the area of the store or attached to the shelves where the products are being picked up. In accordance with a preferred embodiment of the present invention, the advertisers provide focused advertisements to the customer through a PCU (personal communication unit) preferably provided on his shopping cart when the customer is in a predefined location in the confined area.

According to the method of the present invention, after the customer enters to within the confined area, identifying himself to the system, the customer is preferably provided with an interactive PCU which can be one of the following devices: interactive television, computer, contact surface, palm computer, cellular phone, wireless earphones, ePaper etc., and which he may mount on his shopping cart. It is optional that the customer will use the system on his own (PCU) personal communication unit. In this case the system will adapt the campaigns and eaServices to the capabilities of his PCU, to his own specific needs and to any restricted area that he is traveling in. The customer interacts with the PCS being operated by the MSP through the PCU (provided or personal).

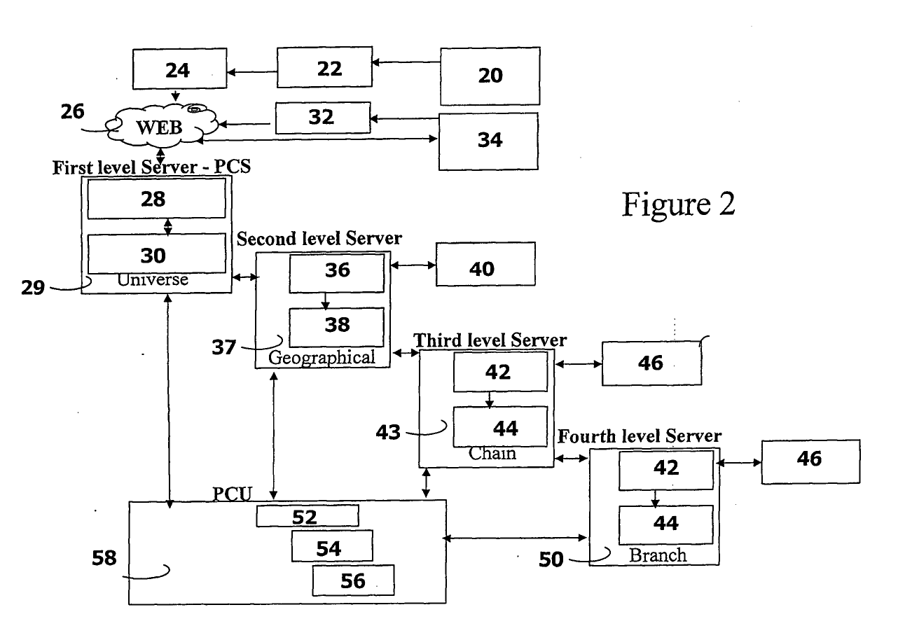

Reference is now made to FIG. 2 schematically illustrating an interactive and adaptive messaging system in accordance with a preferred embodiment of the present invention. As mentioned herein before, information is flowing through the system. Content providers and advertisers create campaigns through a content provider's workstation 20 that collects campaigns information 22 so as to allow a campaign to be created 24. The information is gathered in regular manners as well as new methods and is activated through internet-based software by the advertisers or the owners. On the other hand, information is transferred to web 26 by data collector 32 from a third party server 34. Data collector 32 can collect information through the web from products manufacturer's servers as well as retailer's servers or other databases. In order to form an effective shopping list, there is a need for massive information sources. Using readers like RFID readers or Barcode scanners items can be detected in regards with their location. In case many items are marked using a barcode or an RFID reader, the use of the items or their consumption can be monitored. As an example, RFID reader can be installed in a home litter bag that monitors all items that are being dispensed. The shopping list of the customer can be updated according to this information.

Plurality of campaigns is delivered through a web 26 such as an Internet to a first level server 29 that can be a server of the PCS. The Campaigns are controlled 28 and distributed 30 by a PCS; which is a highest (universal) level that can provide eaServices to a plurality of Second level servers 37 in confined areas geographically distributed.

Second level server 37 comprises campaign control 36 and a campaign distributor 38 that interact with an owners server 40 from which additional information is received.

A third level server 43 that again comprises a campaign control 42 and a campaign distributor 44 is provided in the chain level. The chain level can be a plurality of supermarkets or any other retail chain. An owner server 46 interchanges information with third level server 43.

A similar structured fourth level server 50 can be provided also while it is possible to provide as many levels as needed without limiting the focus of the present invention.

Each level interacts with a PCU (personal communication unit) 58 of the customer as explained herein before, while PCU 58 comprises data collection 52, terminal 54 and a display 56 and is continuously updated. The term terminal is defined as an end user computerized or electronic device.

A campaign may contain presentation information to be presented in various manners such as visual (Picture, Movie, etc.), vocal, textual or any other way and has characteristics that involve parameters such as characteristics of target audience, periods and timing in which the campaign is advertised, locations in which it will be displayed, numbers of exposures, behavior restrictions, intervals etc. The campaign holds information that answer question such as what, how, when, where, to whom, related to what, etc. regarding the advertisements and eaServices offered.

One of the features of the system of the present invention is the ability to store and analyze information regarding the specific customer such as buying habits, lifestyle, personal profile, occupational profile, movements etc. so as to allow focused advertising. The customer identifies himself to the system when he is entering a confined area using any identification feature such as card, name and password, or other identification method like biometric ID and may also be identified automatically by the system. Then, a personalized data package is being transferred to his PCU through the different servers as mentioned herein before. Personalized package may include a predicted reminder list for his specific visit, a list of adapted communication objects such as personalized messages, advertisements, sales promotions, games, coupons, personal news etc., that were created by the advertisers or the owners in campaign creation 24, specially for their target audience or automatically by the system. The campaign controllers are monitoring the actions of the customer and his movements and actions in the confined area and selects and sorts the most relevant information to be displayed and the ads from the personalized data package. For example, if the customer is searching for spaghetti, then the system will look for and add advertisement for parmesan cheese to his data package and to his reminder list. And another example, if the profile of the customer that is received from content provider's server 20 is of a young male that is a student, there will be no substantial advertising material that correspond elderly population. Each campaign can include several related sub campaigns that can include several advertisements, products and information regarding the products such as the prices, sales promotion, an interactive game and news, all according to the information gathered by the system through campaign data collection 22.

It should be noted that the reminder list that is adaptive can be also changed by the customer during his stay in the predetermined area in an interactive manner.

As mentioned, the distribution of the different campaigns is controlled so that the distribution is time and location dependent. The time and location in which a certain campaign is exposed to the customer is controlled by each one of the levels and factors in the system: the advertisers, the owners or retailers, and the customers themselves.

Another issue that is being dealt with in the embodiment of the present invention and in accordance with it is the fact that the exposure of the customer to the advertisement or the information displayed in the PCU is effective. To assure that the customer is indeed in the vicinity of the PCU when the information is displayed, a sensor that can be a biometric sensor is provided in the PCU wherein the sensor indicates to the system whether the customer is in the vicinity of his PCU and is in adequate position to be exposed to the displayed information.

It should be mentioned that when the customer is occupied in a certain activity and the system has the capabilities to monitor his actions, no advertisements will be transferred to his PCU. When there is no relevant information to be displayed to the customer in a specific location, the system will be in a hold position that is cancelled when the customer is moving to another location. Specifically, there is a mechanism that stops ads/messages from annoying the customer. When the customer is working with the device, this mechanism stops any disturbance until a predefined time passes (this time is preferably adjustable). An additional mechanism regulates the load of ads/messages to stop overflowing the customer with them. This mechanism is also adjustable. Optionally, there is an additional mechanism that illuminates an indicator on the PCU's display when the customer location ID has been changed. The customer can choose whether to ignore it and continue what he does or to response to it by activating the indicator which will cause the list of products/service items to be sorted and displayed according to location groups (those that he already visited are first in order of visited location, then those on the current location and last are those that he still did not visit). Each group is preferably marked with a different color.

The system can comprise also a queue ordering mechanism wherein the customer is registered to a line in a specific standpoint in the predetermined area. The unique feature of the present invention is the ability to notify the customer and alert his on the condition of the queue at any given moment.

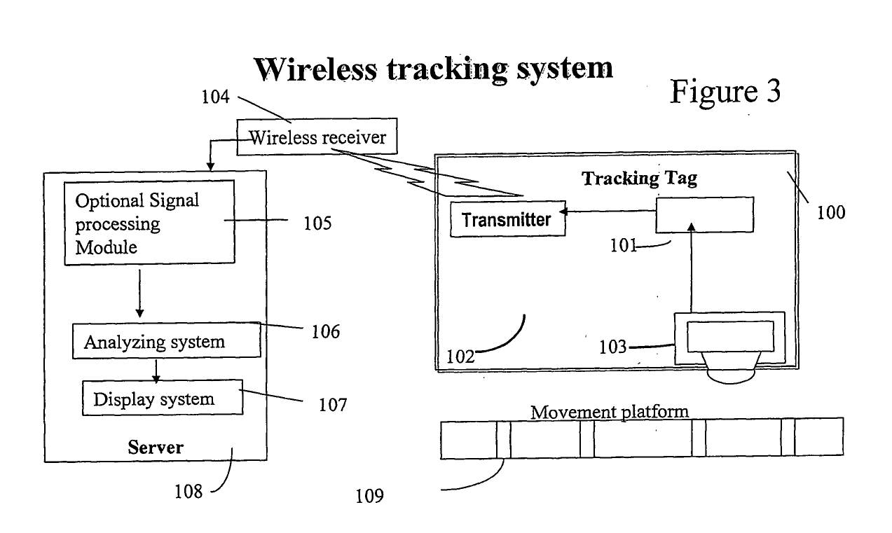

Reference is now made to FIG. 3 schematically illustrating tracking system in the confined area in accordance with a preferred embodiment of the present invention. As mentioned herein before, the customer can be identified by a monitoring system as soon as he enters the predetermined area. Tracking tag 100 allows the system to identify whether the customer is in movement or stationary and his location in the predetermined area. The tag can be active such as tag that transmits Wi-Fi (IEEE 802.11), ZIGBEE (IEEE 802.15) or any RFID or any optical signals especially in case a wireless receiver is used. The location of the tags is identified by wireless receiver 102 that is provided in tag 100 and transmits information by a wireless receiver 104 to a signal processing system 105. The signal is being analyzed by an analyzing system and preferably displayed on a display 107. Tracking tag 100 is adapted to ensure that the server receives the location of the customer in any given time. In order to scale the restricted area in which the user is identified by the system, markings 109 are made preferably on the floor of the area. The markings are detected by a sensor 103 provided in tracking tag 100 wherein the sensor can be a camera, laser or tracking ball that identifies markings 109 and can identify the positioning of the tag. The sensor receives a reference location before the user moved the cart and recalculates its position when the cart is moving. In order to avoid over load on the servers, it is preferable that the reports of location will be delivered to the servers only when the tag had passed a predetermined cell. The restricted area is therefore divided into cells. It is preferable that markings 109 will provide corrections to the location of the tags and the location itself will be resolved through dynamic markings.

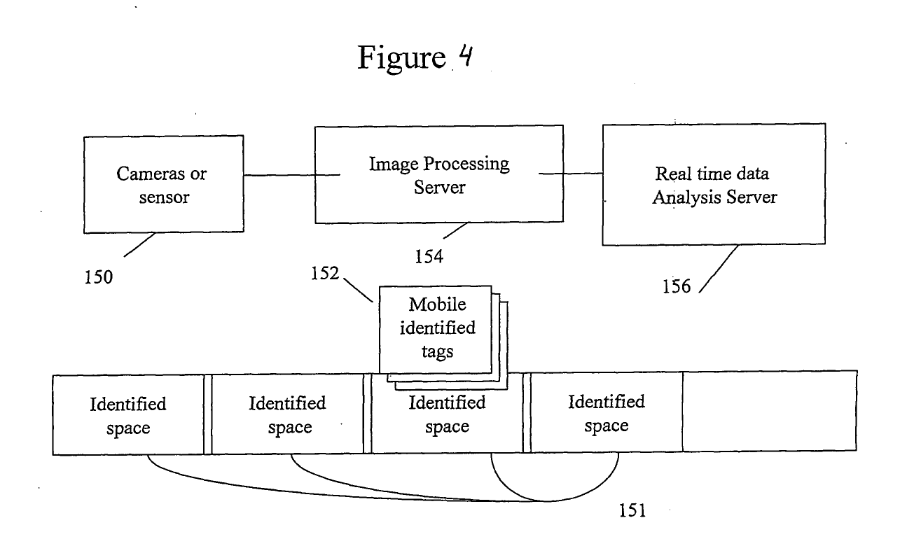

Reference is now made to FIG. 4 schematically illustrating camera-based tracking system in accordance with another preferred embodiment of the present invention. Plurality of cameras 150 are provided in different areas of the predetermined area that are preferably divided into identified spaces 151. The cameras that are preferably video cameras or any optical sensor are photographing plurality of objects (like furniture, store gondolas, refrigerators, cashiers, carts), customers or tags 152 that are preferably a passive tag that can be a LED type based tag or provided with identified combination of colors. Cameras 150 deliver the information to an on-line video server 154 and the information is being analyzed in real time in an analyzing server 156.

It should be mentioned that information received from any one of the subsystems is adapted to be delivered to a main server that can be third party server 34 shown in FIG. 2, for example.

Products are being monitored in a similar manner. Since most nowadays systems are working with barcodes, it is preferable to allow monitoring of products using their bar-codes. Radio-Frequency-based identification of products is also possible. This type of monitoring can be also used in order to provide theft-prevention mechanism and/or planogram control or shelf stock control.

The system tracks plurality of customer's behavior while moving in the predetermined area and sends personal events to be stored in the Media service provider's server, by using TCP/IP Radio Frequency communication. The campaigns that will be delivered to the specific customer are adaptive to the new situation that is being evolved on-line. The system analyzes the shopping or recreation habits of the customer and can predict using a unique and dedicated software programs the needs of the customer according to several dimensions such as: a. shopping history in which statistics on shopping habits is performed, b, time scale—holydays etc. and c. specific needs that are provided by the customer himself such as a shopping list d. customers household status changes e. Customer's behavior while using the PCU in the predetermined area. In accordance to that, any information can be delivered to the customer such as buying lists (his or another); frequencies of buying certain products; special offers; interactive map of the store; coupons; etc. The customer can also make an order through the interactive system (using a touch screen or keypad or speech recognition control). This can be performed also through an SMS or MMS system. Since the system is familiar with the buying habits of the customer and the customer's household members, it provides him with specific coupons adapted to his needs.

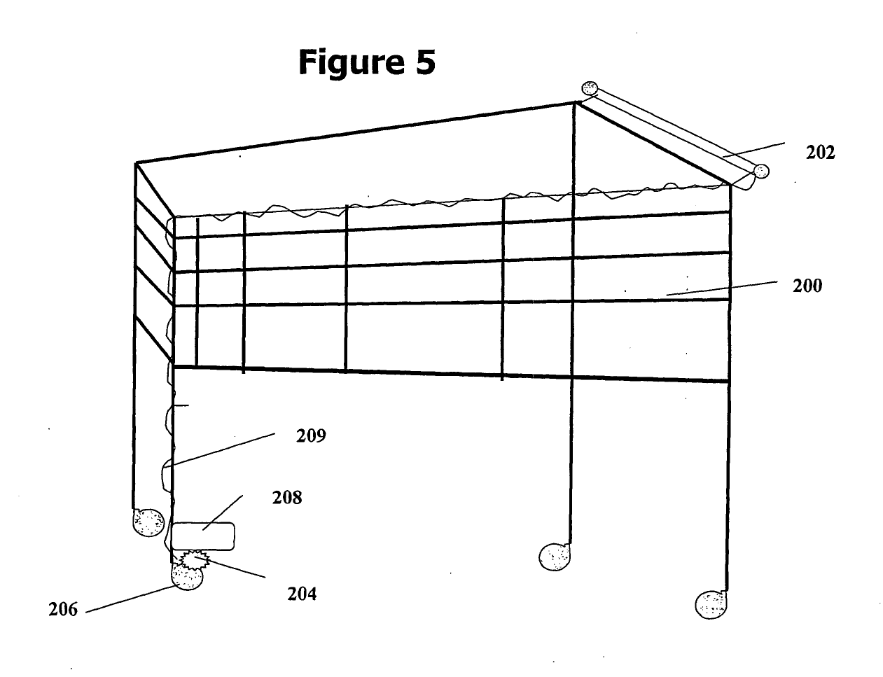

Reference is now made to FIG. 5 illustrating a shopping cart in accordance with a preferred embodiment of the present invention. A shopping cart 200 is designed similar to a regular shopping cart; however, a rechargeable battery 202 is incorporated preferably in the handle of cart 200 or any other suitable location within the cart, so as to charge the communication system and the display or any other electronic device that is preferably located on the cart itself as described herein before.

Optionally, the cart is provided with a charger 204 such as a dynamo type that is adapted to reload when the cart is moving. A charging cable 209 is adapted to allow a connection between the generator and the system that is adapted to be preferably mounted on the shopping cart. Since the communication system is usually operable when the cart is in movement, the dynamo will be attached to one (or more) of the shopping cart's wheels 206 and will be charged as the shopping cart moves.

As mentioned herein before, identification or tracking tag can be provided so as to allow on-line communication in regard with the location of the cart at any time. It is optional to provide a tag 208 attached to one of the cart's wheels or any other position in the bottom of the cart. That tag is incorporated preferably with a CMOS type camera or laser beam, as an example, that will be preferably provided with a plurality of reference points all over the floor of the shopping area. The information regarding the exact location of shopping cart 200 is transmitted preferably through radio communication to a server in an on-line manner or in a frequent manner or according to area divisions in the confined area, as mentioned herein before. The time the cart traveled in a confined area can indicate to the system on shopping habits of the user as mentioned herein before, information that can be used in order to improve the service performed by the system of the present invention. The information is stored on the servers of the communication system. The system can also produce an alarm in case a shopping cart is out of range so as to prevent cart's theft or entering into restricted areas.

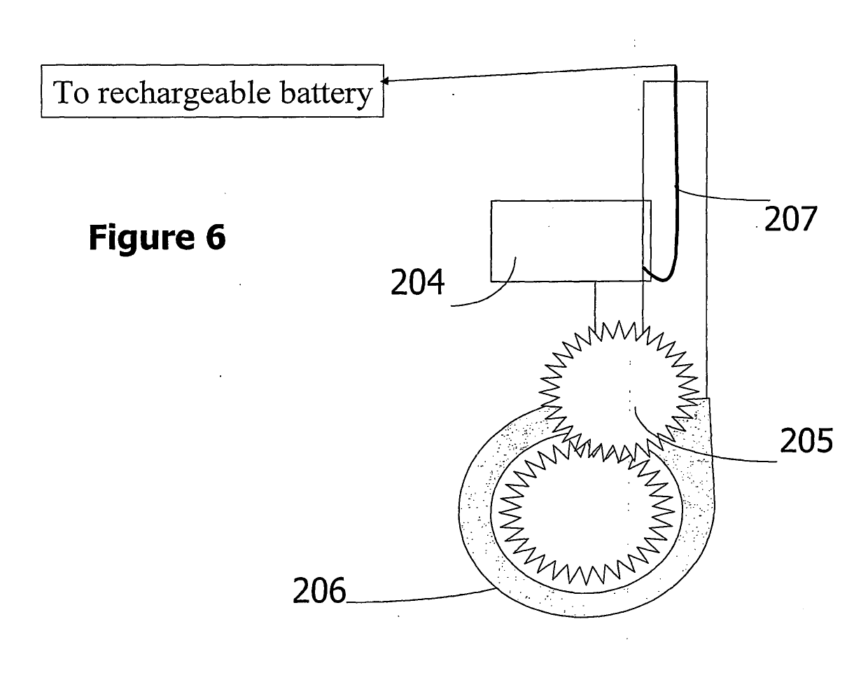

Reference is now made to FIG. 6 illustrating more details of the shopping cart's charger in accordance with a preferred embodiment of the present invention. A power wheel 205 is revolving as a result of the rotation of wheel 206 and delivers the generated electricity to dynamo 204 that transfers the energy through power supply cable 207 so as to energize the communication system that is mounted on the shopping cart.

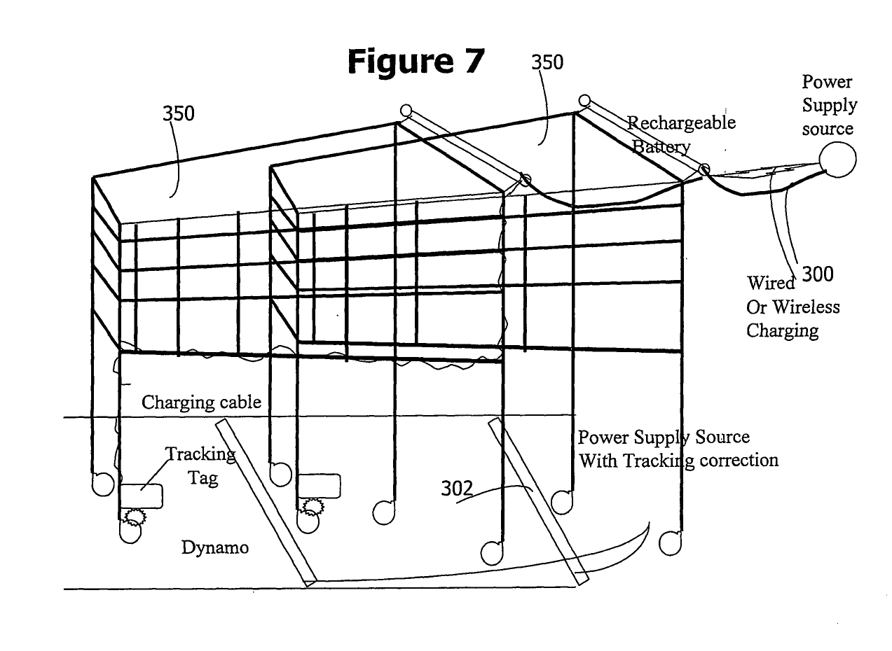

Reference is now made to FIG. 7 illustrating a system for recharging the batteries in the shopping carts in accordance with a preferred embodiment of the present invention. When the shopping carts are not in use, they are usually secured to one another. While secured, the carts can be recharging the batteries of one another preferably through wires 300 that are provided between the carts 350. Carts 350 are powered from a power supply source 302 through an additional wire 304 or through a wireless communication 306. Optionally, power supply sources 302 can be provided on the ground beneath the carts and provide energy to the carts through wireless induction.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1. An interactive and adaptive messaging system adapted to allow effective communication (relationship) between customers, owners of a confined predetermined area and advertisers, the system comprising at least one server adapted to receive content from the customers, the owners, the advertisers, and the predetermined area and to create information and to distribute said information to the customers, wherein a part of the information is distributed when the customer is identified by the messaging system and another part of the information is distributed to the customer according to content received by said at least one server from the customer or from the predetermined area whereby the customers are exposed to the information regularly as they are traveling within the predetermined area as well as at specific locations within the predetermined area.

2. The messaging system as claimed in claim 1, wherein said content received by said at least one server is controlled so as to prevent non relevant information from being loaded into said at least one server.

3. The messaging system as claimed in claim 1, wherein said content received by said at least one servers is processed and analyzed.

4. The messaging system as claimed in claim 1, wherein said information comprises advertising campaigns.

5. The messaging system as claimed in claim 1, further provided with a plurality of tags wherein each one of the tags is adapted to be identified with one of the customers and wherein said plurality of tags are adapted to be identified and monitored when traveling within the confined and predetermined area,

6. The messaging system as claimed in claim 1, wherein a plurality of receivers are provided within the predetermined area and wherein said plurality of receivers are adapted to communicate with said plurality of tags, and wherein information received by said receivers is included in said content.

7. The messaging system as claimed in claim 1, further comprises a plurality of personal communication units (PCU) adapted to be available to the customers in the predetermined area and wherein said plurality of PCU is adapted to be mounted in shopping carts and wherein the information and said advertising campaigns are transmitted to said plurality of PCU.

8. The messaging system as claimed in claim 7, wherein said PCU is selected from a group such as computer monitor, palm computers, or mobile computers.

9. the messaging system as claimed in claim 7, wherein said advertising campaigns is transmitted by a manner that is selected from a group of visual (Picture, Movie, etc.), vocal, or textual.

10. The messaging system as claimed in claim 1, wherein the information received in said at least one receiving server is selected from a group of information such as type of predetermined area, data bases, personal information send by the customers via TCP/IP or Cellular SMS or MMS, or via any other means, and RFID, and barcodes.

11. The messaging system as claimed in claim 1, further comprising a plurality of markers distributed on the predetermined area; and a sensor associated with the customers and adapted to allow localization of the customers within the predetermined area.

12. The messaging system as claimed in claim 11, wherein said sensor is provided on a bottom of plurality of shopping carts wherein said sensor is adapted to identify said plurality of markers.

13. The messaging system as claimed in claim 11, wherein said sensor is a CMOS camera.

14. The messaging system as claimed in claim 11, wherein said shopping carts are provided with batteries.

15. The messaging system as claimed in claim 14, wherein said batteries are rechargeable.

16. The messaging system as claimed in claim 15, wherein said batteries are recharged in a manner such as induction or a generator.

17. The messaging system as claimed in claim 16, wherein said generator is a dynamo generator that is activated by movements of the shopping cart.

18. The messaging system as claimed in claim 1, wherein said predetermined area is divided into a plurality of sections and wherein a reminder list is adapted to be updated according to movements of the customers among said plurality of sections.

19. The messaging system as claimed in claim 18, wherein the customer receives an indication that he has moved to one of said plurality of sections.

20. The messaging system as claimed in claim 19, wherein the customer can activate an updating procedure of said reminder list in response to said indicator.

21. The messaging system as claimed in claim 1, further comprising a tracking system adapted to identify the positioning of the customer or the shopping cart in the predetermined area.

22. The messaging system as claimed in claim 21, wherein said tracking system comprises at least one camera.

23. The messaging system as claimed in claim 1, wherein said content can be received from identified items that are being purchased by the customers.

24. The messaging system as claimed in claim 1, wherein said content can be received from identified items that are being dispensed by the customers.

25. The messaging system as claimed in claims 23 or 24, wherein said identified items are provided with an identification means selected from a group of means such as barcode or RFID tag.

26. The messaging system as claimed in claim 1, wherein predetermined area is selected from a group of areas such as retailer's chains, airport area, airplanes, train stations, the trains themselves, boats, mall, parks.

27. A method of interactive and adaptive communication and relationship between customers, owners of a confined predetermined area and advertisers comprising:
collecting content to at least one server from the customers, the owners the advertisers, and the predetermined area;
creating information;
distributing a part of said information through said at least one server to the customers when the customer is identified in the predetermined area;
tracking the customers within the predetermined area;
transferring location content to said at least one server;
distributing another part of the information to the customers according to content received by said at least one server and to said location content;
whereby the customers are exposed to the information regularly as they are traveling within the predetermined area as well as at specific locations within the predetermined area.
